(19) United States
(12) Patent Application Publication
(10) Pub. No.: US 2018/0096639 A1
(43) Pub. Date: Apr. 5, 2018

(54) LIGHT GUIDING PLATES, BACKLIGHT MODULES, AND DISPLAY DEVICES

(71) Applicant: Shenzhen China Star Optoelectronics Technology Co. Ltd., Shenzhen, Guangdong (CN)

(72) Inventors: Jianyu CHANG, Shenzhen, Guangdong (CN); Jinxiong CHEN, Shenzhen, Guangdong (CN)

(73) Assignee: Shenzhen China Star Optoelectronics Technology Co., Ltd., Shenzhen, Guangdong (CN)

(21) Appl. No.: 15/100,444

(22) PCT Filed: May 12, 2016
(86) PCT No.: PCT/CN2016/081853

§ 371 Date: May 31, 2016

(30) Foreign Application Priority Data
Apr. 25, 2016 (CN) 201610261922.7

(51) Int. Cl. G09G 3/06; F21V 8/00

(52) U.S. Cl. CPC G09G 3/06; G02B 6/0055

(57) ABSTRACT

A light guiding plate includes a light incident surface, a light emitting surface, a reflective surface, and a first reflective surface. The light emitting surface is opposite to the reflective surface. A first reflective surface connects the light emitting surface and the light incident surface. The light incident surface connects the first reflective surface and the reflective surface. The light incident surface is configured for receiving light beams from a light source. The first reflective surface and an extended surface of the light emitting surface form a first angle, and the first angle is an acute angle. The present disclosure also relates to a backlight module and a display device. The light guiding plate is capable of enhancing the display performance of the display device.

### CROSS REFERENCE

This application claims the priority of Chinese Patent Application No. 201610261922.7, entitled “Light guiding plates, backlight modules, and display devices”, filed on Apr. 25, 2016, the disclosure of which is incorporated herein by reference in its entirety.

### FIELD OF THE INVENTION

The present invention relates to a backlight source technology field, and more particularly to a light guiding plate and a backlight module.

### BACKGROUND OF THE INVENTION

backlight modules are usually of edge-lite structures, that is, the light source is arranged in a lateral surface of the light guiding plate. In other words, the lateral surface of the light guiding plate is the light incident surface, and a top surface of the light guiding plate is the light emitting surface. Usually, a reflective sheet is arranged in a bottom surface of the light guiding plate so as to reflect more light beams to the light emitting surface. However, as the light guiding plate is of the cuboid-shaped, the lateral surface of the light guiding plate is perpendicular to the top surface and the bottom surface. As such, bright stripes may occur on the light emitting surface close to the light incident surface of the light guiding plate. The reason is that the bright stripes are close to the light source, and the reflected light beams concentrate on an area. The bright stripes may result in bad display performance.

### SUMMARY OF THE INVENTION

According to the present disclosure, the proposed light guiding plate, the backlight module, and the display device may solve the bright stripes issue as stated above so as to enhance the display performance.

In one aspect, alight guiding plate includes: a light incident surface, a light emitting surface, a reflective surface, and a first reflective surface, the light emitting surface is opposite to the reflective surface, a first reflective surface connects the light emitting surface and the light incident surface, the light incident surface connects the first reflective surface and the reflective surface, the light incident surface is configured for receiving light beams from a light source, the first reflective surface and an extended surface of the light emitting surface form a first angle, and the first angle is an acute angle.

Wherein the first angle is greater than 0 degree and is smaller than or equals to 35 degrees.

Wherein the light guiding plate further includes a second reflective surface connected between the light incident surface and the reflective surface, the second reflective surface and the extended surface of the reflective surface form a second angle, and the second angle is an acute angle.

Wherein the second angle is greater than 0 degree and is smaller than or equals to 35 degrees.

Wherein the second reflective surface and the first reflective surface are symmetrically arranged at two lateral sides of the light incident surface.

Wherein the second reflective surface and/or the first reflective surface are planar.

Wherein surfaces of the first reflective surface and/or the second reflective surface are coated with a reflective layer.

In another aspect, a backlight module includes the above light guiding plate and a light source. The light source faces toward the light incident surface of the light guiding plate.

Wherein the backlight module further includes a reflective sheet adhered to the reflective surface via optical glue.

In another aspect, a display device includes the above backlight module.

In view of the above, the first reflective surface is arranged between the light incident surface and the light emitting surface. The first reflective surface and the extended surface of the light emitting surface form the first angle, which is an acute angle such that after the light beams radiate on the first reflective surface, the light beams are reflected to a first location of the reflective surface.

If the first reflective surface is not configured, the light beams with the same angle radiate on the extended surface of the light emitting surface. The extended surface of the light emitting surface reflects the light beams to the second location on the reflective surface 13. The first location is closer to the light incident surface than the second location. That is, with the configuration of the first reflective surface, the light beams closer to the light source are pulled away. In other words, the light beams close to the light source are weakened such that the bright stripes issue may be eliminated so as to enhance the display performance.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view of the light guiding plate in accordance with one embodiment.

FIG. 2 is a schematic view showing a portion of the light guiding plate in accordance with one embodiment.

FIG. 3 is a schematic view showing a portion of the light guiding plate in accordance with another embodiment.

FIG. 4 is a schematic view showing the transmission of three light beams of the conventional light guiding plate.

FIG. 5 is a schematic view showing the transmission of three light beams of the light guiding plate in accordance with one embodiment.

FIG. 6 is a schematic viewshowing the effect caused by the relationship between the size “X” of the first light reflective surface corresponding to the light emitting surface and the size “Y” of the first light reflective surface corresponding to the light incident surface toward the peak of the bright stripes in accordance with one embodiment.

FIG. 7 is a curved diagram showing the relationship between the first angle and the peak of the bright stripes in accordance with one embodiment.

FIG. 8 is a curved diagram showing the relationship between the first angle and the coupling efficiency in accordance with one embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

The present disclosure relates to a light guiding plate, a backlight module and a display device. The light guiding plate incorporated by the backlight module of the display device may solve the bright stripes issues to enhance the display performance. The backlight module includes the light guiding plate and the light source facing toward the light incident surface of the light guiding plate. The backlight module also includes a reflective sheet adhered to a reflective surface via optical glues.

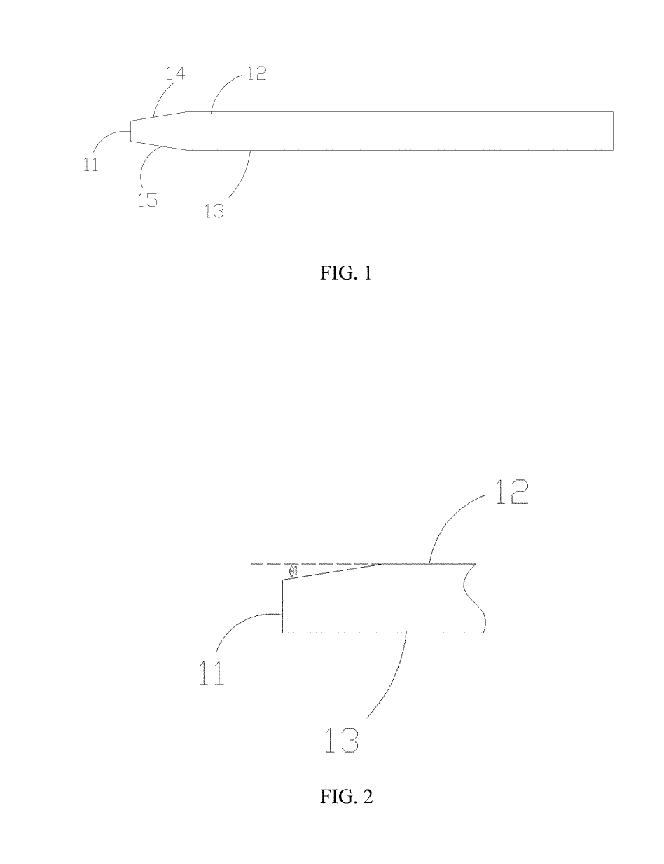

Referring to FIG. 1, the light guiding plate is substantially cuboid-shaped. The light guiding plate includes a light incident surface 11, a light emitting surface 12, a reflective surface 13, and a first reflective surface 14. With respect to the configuration of FIG. 1, the light emitting surface 12 and the reflective surface 13 are respectively the top surface and the down surface, and the light incident surface 11 is a lateral surface. The first reflective surface 14 is formed on an edge of the light emitting surface 12. The light emitting surface 12 is opposite to the reflective surface 13. The first reflective surface 14 connects the light emitting surface 12 and the light incident surface 11. The light incident surface 11 connects the first reflective surface 14 and the reflective surface 13. The light incident surface 11 is configured for receiving light beams from a light source. The first reflective surface 14 and an extended surface of the light emitting surface 12 form a first angle (θ1). As shown in FIG. 2, the dashed line shows the extended surface of the light emitting surface 12. That is, the extended surface of the light emitting surface 12 is at a rim of the light emitting surface 12 and is on the same plane with the light emitting surface 12.

The first angle (θ1) is an acute angle. Specifically, the first angle (θ1) is greater than 0 degree and is smaller than or equals to 35 degrees.

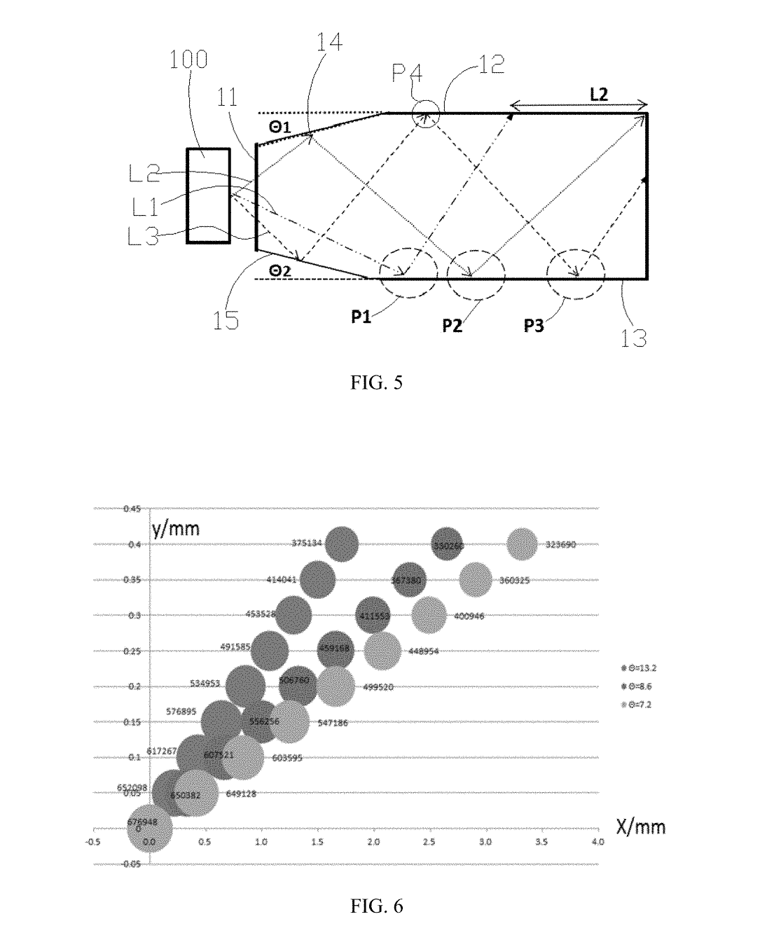

In one embodiment, the first reflective surface 14 is arranged between the light incident surface 11 and the light emitting surface 12. The first reflective surface 14 and the extended surface of the light emitting surface 12 form the first angle (θ1), which is an acute angle such that after the light beams radiate on the first reflective surface 14, the light beams are reflected to a first location of the reflective surface 13. Referring to FIG. 5, the three areas on the reflective surface marked as P1, P2, and P3 relate to the first location. If the first reflective surface 14 is not configured, the light beams with the same angle radiate on the extended surface of the light emitting surface 12. As shown in FIG. 4, the extended surface of the light emitting surface 12 reflects the light beams to the second location on the reflective surface 13 (the second location is denoted by “P.” The first location is closer to the light incident surface than the second location. That is, with the configuration of the first reflective surface 14, the light beams closer to the light source are pulled away. In other words, the light beams close to the light source are weakened such that the bright stripes issue may be eliminated so as to enhance the display performance.

The light incident surface 11 may directly connect with the reflective surface 13. Only the edge of the light emitting surface 12 close to the light incident surface 11 has been applied with a grinding or an cutting angle process to form the first reflective surface 14 between the light emitting surface 12 and the light incident surface 11. The light incident surface 11 is perpendicular to the reflective surface 13.

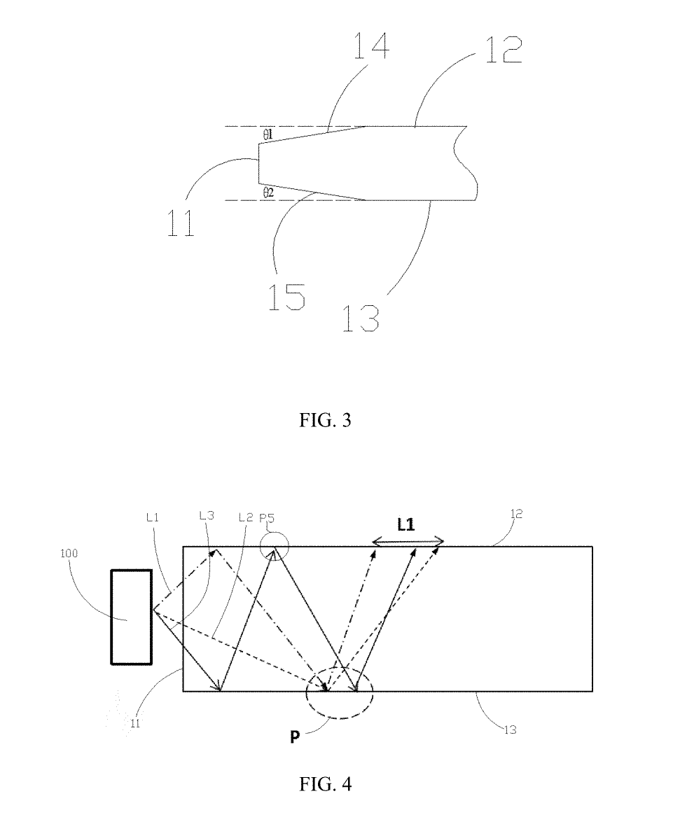

A second reflective surface 15 may be configured between the light incident surface 11 and the reflective surface 13. As shown in FIG. 3, the second reflective surface 15 connects the light incident surface 11 and the reflective surface 13. The second reflective surface 15 and the extended surface of the reflective surface 13 form a second angle (θ2), and the second angle (θ2) is an acute angle. The second angle (θ2) is greater than 0 degree and is smaller than or equals to 35 degrees.

The operation principle of the second reflective surface 15 is the same with that of the first reflective surface 14. The light beams radiates on the second reflective surface 15 are reflected by the second reflective surface 15, and then arrive a third location of the light emitting surface 12. As shown in FIG. 5, the third location is denoted by “P4.” When the second reflective surface is not configured, the light beams with the same angle radiate on the extended surface of the reflective surface 13, as shown in FIG. 4. The extended surface of the reflective surface 13 further reflects the light beams toward the fourth location of the light emitting surface 12. As shown in FIG. 4, the fourth location is marked as “P5.” The third location is closer to the light incident surface than the fourth location. That is, the light beams closer to the light source are pulled away after being reflected by the second reflective surface 15. In other words, the light beams close to the light source are weakened such that the bright stripes issue may be eliminated so as to enhance the display performance.

In one embodiment, the second reflective surface 15 and the first reflective surface 14 are symmetrically arranged at two lateral sides of the light incident surface.

In one embodiment, the second reflective surface 15 and/or the first reflective surface 14 are planar, which contributes to the manufacturing process and may realize uniform reflective effect at the same time. In other embodiment, the surfaces of the first reflective surface 14 and/or the second reflective surface 15 may be configured with micro-protrusions to realize different reflection effects. In other examples, the surfaces of the first reflective surface 14 and/or the second reflective surface 15 are configured to be curved or sawtooth-shaped.

Further, the surfaces of the first reflective surface 14 and/or the second reflective surface 15 may be coated with a reflective layer to increase the reflection effects.

Referring to FIGS. 4 and 5, optical paths of the three light beams (L1, L2, and L3) of the light guiding plate are shown. In view of FIGS. 4 and 5, it can be clearly seen that the light guiding plate weakens the bright stripes issues. Referring to FIG. 4, after the three light beams (L1, L2, and L3) emitted from the light source 100 enter the light guiding plate, the light beams concentrate on the area of the reflective surface 13 denoted by “P.” After being reflected by the reflective surface 13, the light beams emit out from the area of the light emitting surface 12 denoted as “L1.” Referring to FIG. 5, after the three light beams (L1, L2, and L3) emitted from the light source 100 enter the light guiding plate, the light beams respectively radiates on the three areas of the light emitting surface 12 denoted as “P1”, “P2” and “P3.” A gap between the two light beams is “L2”, and the other light beam falls outside the area denoted as “L2.” Referring to FIG. 4, the area denoted as “L1” is the bright stripe area. Referring to FIG. 5, the number of the light beams within the area denoted as “L2” is decreased. In addition, the area denoted as “L2” is farther to the light source than the area denoted as “L1.” Also, the dimension of the area denoted as “L2” is greater than the dimension of the area denoted as “L1.”

FIG. 6 is a schematic view showing the effect caused by the relationship between the size “X” of the first light reflective surface corresponding to the light emitting surface and the size “Y” of the first light reflective surface corresponding to the light incident surface toward the peak of the bright stripes in accordance with one embodiment. In view of FIG. 6, it can be understood that when the first angle (θ1) is fixed, the bright stripe peak gradually decreases when the horizontal length component and the vertical length component of the first angle (θ1), i.e., the size of X or Y, are increased. Also, the decreasing trend of the bright stripes may be different when the first angle (θ1) is different. FIG. 6 shows the experimental results of the three different first angles (θ1), i.e., 13.2, 8.6, and 7.2 degrees. Regarding the relationship between the second reflective surface, the second angle (θ2), and the bright stripe peak, as shown in FIG. 6, the first reflective surface 14 and the first angle (θ1) has similar relationship with respect to the bright stripe peak.

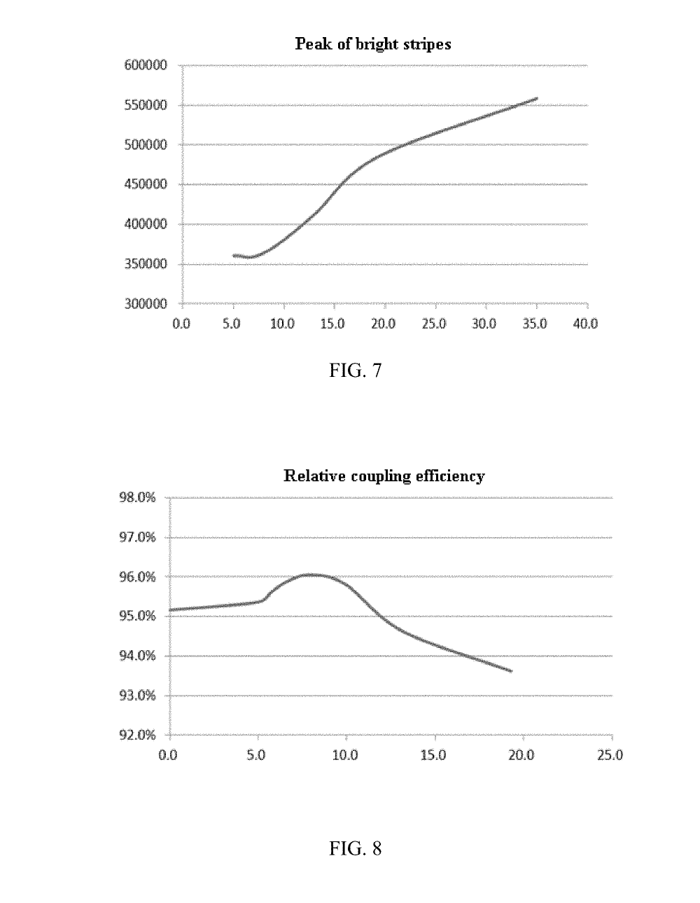

FIG. 7 is a curved diagram showing the relationship between the first angle (θ1) and the peak of the bright stripes in accordance with one embodiment. It can be conceived in view of FIG. 7 that when the first angle (θ1) is within a range between 0 and 35 degrees, the bright stripe peak is smaller when the first angle (θ1) is smaller, that is, the bright stripes are weakened.

FIG. 8 is a curved diagram showing the relationship between the first angle and the coupling efficiency in accordance with one embodiment. With the configuration of the light guiding plate, the coupling efficiency remains above 90% when there is no cutting angle. In view of FIG. 8, it can be conceived that when the first angle (θ1) is within the range between 0 and 20 degrees, the coupling efficiency may be above 93% when there is no cutting angle.

Above are embodiments of the present invention, which does not limit the scope of the present invention. Any modifications, equivalent replacements or improvements within the spirit and principles of the embodiment described above should be covered by the protected scope of the invention.

What is claimed is:

1. A light guiding plate, comprising:
a light incident surface, a light emitting surface, a reflective surface, and a first reflective surface, the light emitting surface is opposite to the reflective surface, a first reflective surface connects the light emitting surface and the light incident surface, the light incident surface connects the first reflective surface and the reflective surface, the light incident surface is configured for receiving light beams from a light source, the first reflective surface and an extended surface of the light emitting surface form a first angle, and the first angle is an acute angle.

2. The light guiding plate as claimed in claim 1, wherein the first angle is greater than 0 degree and is smaller than or equals to 35 degrees.

3. The light guiding plate as claimed in claim 1, wherein the light guiding plate further comprises a second reflective surface connected between the light incident surface and the reflective surface, the second reflective surface and the extended surface of the reflective surface form a second angle, and the second angle is an acute angle.

4. The light guiding plate as claimed in claim 3, wherein the second angle is greater than 0 degree and is smaller than or equals to 35 degrees.

5. The light guiding plate as claimed in claim 3, wherein the second reflective surface and the first reflective surface are symmetrically arranged at two lateral sides of the light incident surface.

6. The light guiding plate as claimed in claim 3, wherein the second reflective surface and/or the first reflective surface are planar.

7. The light guiding plate as claimed in claim 3, wherein surfaces of the first reflective surface and/or the second reflective surface are coated with a reflective layer.

8. A backlight module, comprising:
a light guiding plate and a light source, the light guiding plate comprises a light incident surface, a light emitting surface, a reflective surface, and a first reflective surface, the light emitting surface is opposite to the reflective surface, a first reflective surface connects the light emitting surface and the light incident surface, the light incident surface connects the first reflective surface and the reflective surface, the light incident surface is configured for receiving light beams from a light source, the first reflective surface and an extended surface of the light emitting surface form a first angle, and the first angle is an acute angle, and the light source faces toward the light incident surface of the light guiding plate.

9. The backlight module as claimed in claim 8, wherein the backlight module further comprises a reflective sheet adhered to the reflective surface via optical glue.

10. The backlight module as claimed in claim 8, wherein the light guiding plate further comprises a second reflective surface connected between the light incident surface and the reflective surface, the second reflective surface and the extended surface of the reflective surface form a second angle, and the second angle is an acute angle.

11. The backlight module as claimed in claim 10, wherein the second reflective surface and the first reflective surface are symmetrically arranged at two lateral sides of the light incident surface.

12. The backlight module as claimed in claim 10, wherein the first angel and the second angle are greater than 0 degree and are smaller than or equal to 35 degrees.

13. The backlight module as claimed in claim 10, wherein the second reflective surface and/or the first reflective surface are planar.

14. The backlight module as claimed in claim 10, wherein surfaces of the first reflective surface and/or the second reflective surface are coated with a reflective layer.

15. A display device, comprising:
a backlight module having a light guiding plate and a light source, the light guiding plate comprises a light incident surface, a light emitting surface, a reflective surface, and a first reflective surface, the light emitting surface is opposite to the reflective surface, a first reflective surface connects the light emitting surface and the light incident surface, the light incident surface connects the first reflective surface and the reflective surface, the light incident surface is configured for receiving light beams from a light source, the first reflective surface and an extended surface of the light emitting surface form a first angle, and the first angle is an acute angle, and the light source faces toward the light incident surface of the light guiding plate.

16. The display device as claimed in claim 15, wherein the light guiding plate further comprises a second reflective surface connected between the light incident surface and the reflective surface, the second reflective surface and the extended surface of the reflective surface form a second angle, and the second angle is an acute angle.

17. The display device as claimed in claim 16, wherein the second reflective surface and the first reflective surface are symmetrically arranged at two lateral sides of the light incident surface.

18. The display device as claimed in claim 16, wherein the first angel and the second angle are greater than 0 degree and are smaller than or equal to 35 degrees.

19. The display device as claimed in claim 16, wherein the second reflective surface and/or the first reflective surface are planar.

20. The display device as claimed in claim 16, wherein surfaces of the first reflective surface and/or the second reflective surface are coated with a reflective layer.
